(19) United States
(12) Patent Application Publication
(10) Pub. No.: US 2026/0139519 A1
(43) Pub. Date: May 21, 2026

(54) COMPUTING DEVICES WITH LOCKING CABLES

(71) Applicant: Hewlett-Packard Development Company, L.P., Spring, TX (US)

(72) Inventors: Hyunmin Moon, Spring, TX (US); Chrome Manley Cebe, Palo Alto, CA (US); Kuochih Huang, Taipei City (TW); Cuong-Ted Nguyen, Spring, TX (US)

(73) Assignee: Hewlett-Packard Development Company, L.P., Spring, TX (US)

(21) Appl. No.: 18/952,125

(22) Filed: Nov. 19, 2024

(51) Int. Cl. E05B 73/00; G06F 3/02

(52) U.S. Cl. CPC E05B 73/0082; E05B 73/0011; G06F 3/0202

(57) ABSTRACT

A computing device may include a casing having an aperture. The computing device may include a motherboard affixed to the casing. The motherboard may include an input/output (I/O) port. The computing device may also include a locking cable. The locking cable may include a first end to connect to the I/O port. The first end may be disposed in the casing. The locking cable may also include a body connected to the first end. The body may extend from inside the casing to outside the casing through the aperture. The locking cable may also include a second end connected to the body. The second end may include an I/O connector to interface with an electronic device.

### BACKGROUND

Computing devices can be provided for public use in various environments, for example, in schools and libraries.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several examples in accordance with the disclosure and are not to be considered limiting of its scope, the disclosure will be described with additional specificity and detail through use of the accompanying drawings. In the drawings, similar symbols typically identify similar components, unless context dictates otherwise. The illustrative examples described in the detailed description, drawings, and claims are not meant to be limiting. Other examples may be utilized, and other changes may be made, without departing from the spirit or scope of the subject matter presented here. The drawings are drawn to scale, but such scale should not be interpreted as limiting and some features may be enlarged or reduced for purposes or presentation. The drawings may omit some features for the sake of clarity. The relative dimensions and proportions as shown are not intended to limit the present disclosure. It will be readily understood that the aspects of the present disclosure, as generally described herein, and illustrated in the figures, can be arranged, substituted, combined, and designed in a wide variety of different configurations, all of which are explicitly contemplated and make part of the present disclosure.

FIG. 1A illustrates an example computing device.

FIG. 1B illustrates a bottom perspective view of the computing device of FIG. 1A with a locking cable.

FIG. 2 illustrates a bottom perspective view of the computing device of FIG. 1A with a portion of a casing removed for illustrative purposes.

FIG. 3A illustrates an example securement in a locked configuration.

FIG. 3B illustrates the securement of FIG. 3A in an unlocked and retracted configuration.

FIG. 4 illustrates an exploded view of the securement of FIG. 3A.

FIGS. 5A-5D side views of the securement of FIG. 3A (with certain internal components visible) and illustrate stages of an example method of locking the locking device of FIG. 3A.

FIGS. 6A-6B side views of the securement of FIG. 3A (with certain internal components visible) and illustrate stages of an example method of unlocking the locking device of FIG. 3A.

### DETAILED DESCRIPTION

The present disclosure generally relates to computing devices with locking cables and locking devices to prevent or limit theft of computing devices and peripheral devices from public spaces, for example, computing devices provided for public use in libraries or schools. Example methods of using the locking cables and locking devices are also disclosed. The computing devices described herein provide affordable solutions that can assist in deterring the theft of the computing devices and peripheral devices.

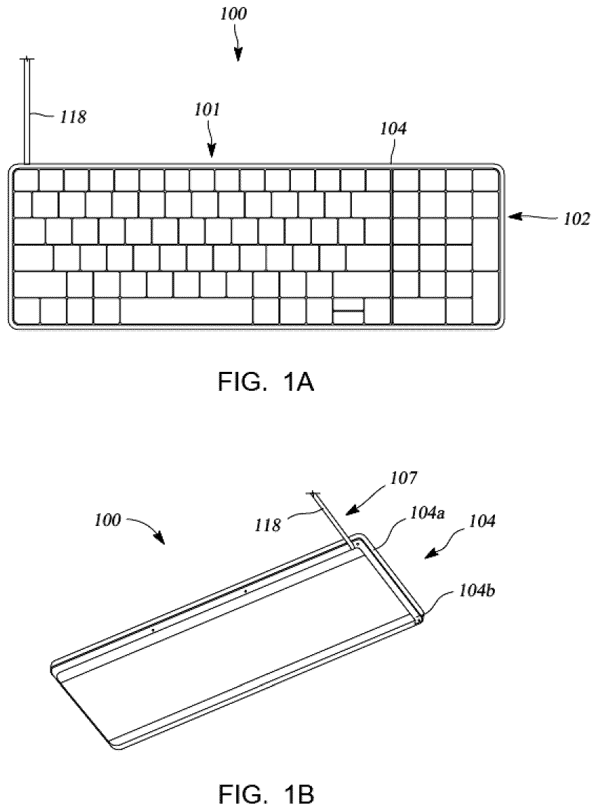

FIGS. 1A and 1B illustrate an example computing device 100. The computing device 100 can be a keyboard with computing capabilities (e.g., a “keyboard PC”). For example, the computing device 100 can include a motherboard 108, which can have various processor and/or memory components. As shown, the computing device 100 can include a keyboard 101 and/or a numerical pad 102. The keyboard 101 and the numerical pad 102 can be separate pieces or a unitary structure. In some implementations, the computing device 100 is connected to an external display (not shown), such as an LCD or other type of screen.

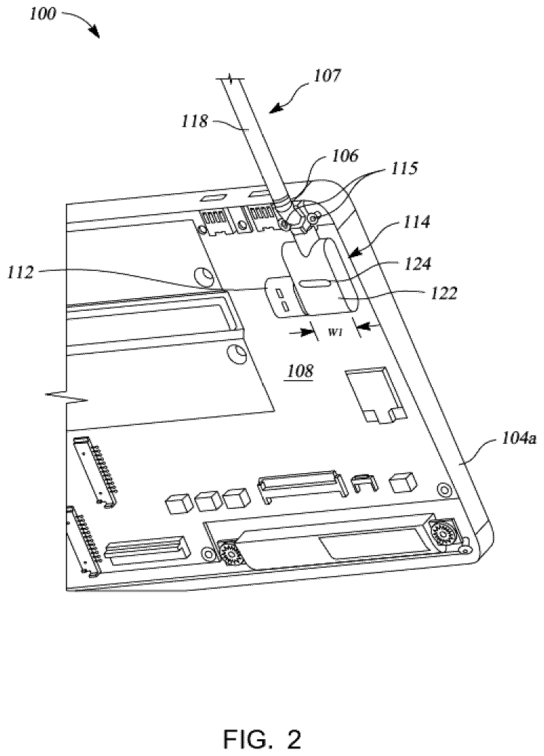

The computing device 100 can include a casing 104. The motherboard 108 can be inside and affixed to the casing 104. The casing 104 can include a first portion 104a and a second portion 104b. The first portion can be attachable and removable from the second portion. For example, FIG. 2 illustrates the casing 104 with the second portion 104b removed.

The casing 104 can include an aperture 106. The aperture 106 can be bounded at least in part by the first portion 104a and the second portion 104b of the casing 104. The aperture 106 can receive a locking cable 107. The locking cable 107 can couple the computing device 100 to a peripheral. For example, the locking cable 107 can couple the computing device 100 to an electronic device (e.g., a mouse), a monitor, or a power source. In some implementations, the locking cable 107 is to convey power and/or signals to and/or from the computing device 100. For example, the locking cable 107 can be an input/output (I/O) cable.

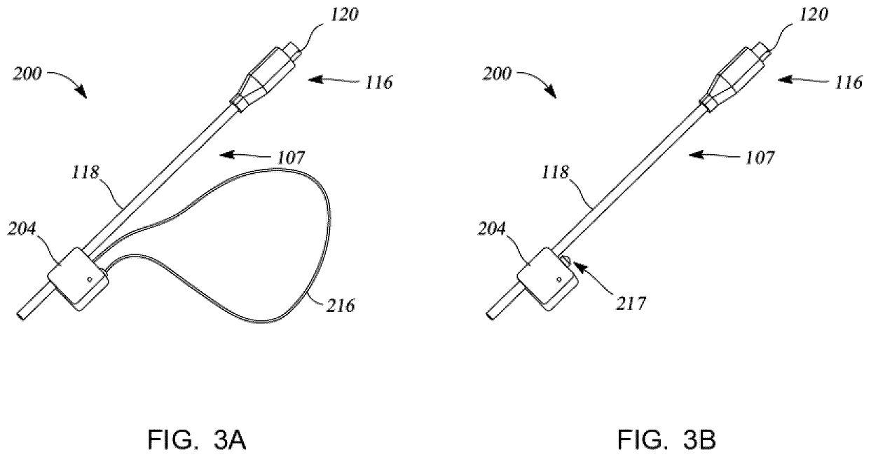

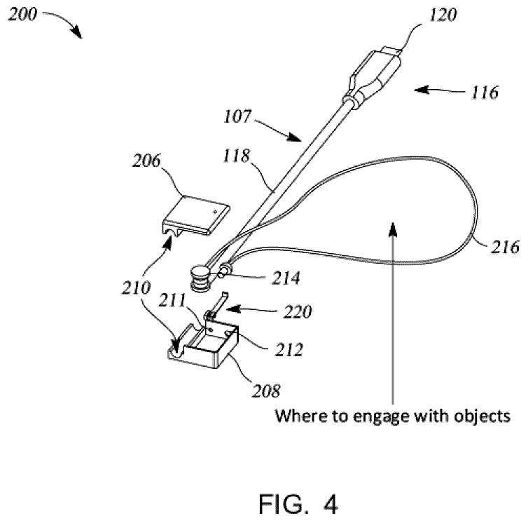

The locking cable 107 can have a first end 114, a second end 116 (see FIGS. 3A-4), and a body 118 extending from the first end 114 to the second end 116. The first end 114 can be disposed in the casing 104. For example, the first end 114 can be enclosed between the first portion 104a and the second portion 104b of the casing 104. The first portion 104a and the second portion 104b of the casing 104 can be secured together with fasteners (e.g., screws) to inhibit or prevent an unauthorized individual from easily separating the portions of the casing 104 to free the first end 114. The first end 114 can connect to an I/O port 112 of the motherboard. The body 118 can extend from inside the casing 104 to outside the casing 104 through the aperture 106. The second end 116 can include a connector 120 (see FIGS. 3A-4). The connector 120 can be an I/O connector. The connector 120 can interface with an external device (not shown), such as an electronic device, a monitor, or a power source. For example, the second end 116 can connect to or include a plug for accessing electrical power.

The first end 114 of the locking cable 107 can include a plug 122. The plug 122 can couple with the I/O port 112. The plug 122 can be oriented at a non-zero angle relative to a longitudinal axis of the body 118 of the locking cable 107 or the casing 104. For example, the plug 122 can be oriented to engage (e.g., be inserted into or removed from) the port 112 at an angle that is generally perpendicular to the longitudinal axis of the body 118 and/or generally parallel to a longitudinal axis of the casing 104. The angled orientation of the plug 122 relative to the body 118 of the locking cable 107 can facilitate maintaining a secure connection with the I/O port 112 and/or reduce the chance of theft. For example, if an unauthorized individual were to pull or apply a force to the locking cable 107 in an effort to try and unplug the locking cable 107, the orientation of the plug 122 can reduce the chance that the plug 122 would be uncoupled with the I/O port 112. In various implementations, the first portion 104a and the second portion 104b of the casing 104 first need to be separated before the plug 122 can be removed from the I/O port 112.

The locking cable 107 can provide a physical interference that inhibits unauthorized removal from the casing 104. For example, the first end 114 of the locking cable 107 can have a width W1 that exceeds a width or diameter of the aperture 106. The width W1 can prevent the first end 114 of the locking cable 107 from being removed from the casing 104 through the aperture 106. For example, an unauthorized individual would need to separate the first portion 104a and the second portion 104b of the casing 104 in order to remove the first end 114 of the locking cable 107 from within the casing 104. This can help inhibit or prevent theft of the computing device.

The locking cable 107 can include a first portion of the body 118 that is angled relative to a second portion of the body 118. The first portion of the body 118 can be inside the casing 104 and the second portion of the body 118 can be outside the casing 104. As mentioned above, the angled nature of the locking cable 107 can assist in inhibiting or preventing an unauthorized individual from removing the first end 114 of the locking cable 107 from within the casing 104. For example, the angled configuration can assist in making the first end 114 physically larger than aperture 106 and/or larger than a non-angled configuration. The angled nature of the locking cable 107 can be advantageous in maintaining a secure connection with the I/O port 112 in the event an unauthorized individual attempts to unplug the plug 122 from the I/O port 112.

As can be seen from FIG. 2, in some implementations, the locking cable 107 is located sufficiently close to a sidewall of the casing 104 that the locking cable 107 is inhibited or prevented from being disengaged from the port 112 unless the second portion is removed from the first portion. For example, a distance needed to disengage the locking cable 107 from the port 112 can be greater than a distance between the locking cable 107 and a sidewall of the second portion.

The first end 114 of the locking cable 107 can be secured to the casing 104 via fasteners, such as screws 115. The screws 115 can make it harder for an unauthorized individual to remove the first end 114 of the locking cable 107 from within the casing 104. For example, the unauthorized individual would need to separate the first portion 104a and the second portion 104b of the casing 104 and then unscrew the screws 115 to detach the locking cable 107 from the casing 104.

In certain implementations, the locking cable 107 physically engages with the casing 104. For example, the first end 114 of the locking cable 107 can include a recess 124, which can receive a protrusion on an inner surface of the casing 104. Alternatively, the first end 114 of the locking cable 107 can include a protrusion while an inner surface of the casing 104 can include a recess to receive the protrusion. The corresponding recess 124 and protrusion can provide a physical engagement between the locking cable 107 and the casing 104. This can assist in securing the first end 114 of the locking cable 107 within the casing 104, reduce the risk of an unauthorized individual being able to detach the locking cable 107 from the casing 104, and/or assist in ensuring a good connection between the plug 122 and the I/O port 112.

FIGS. 3A-4 illustrate an example securement 200. The securement 200 can be used to secure the computing device 100 to a stationary object, for example, a table leg or a chair leg. The securement 200 can also be used to secure non-computing devices, such as a mouse, display, keyboard, etc. The securement 200 can assist in preventing or reducing the chance of theft of the computing device 100. FIG. 3A illustrates the securement 200 in a locked configuration, while FIG. 3B illustrates the securement 200 in an unlocked configuration. FIG. 4 illustrates an exploded view of the securement 200.

The securement 200 can include a lock casing 204. The lock casing 204 can couple to the locking cable 107. The lock casing 204 can couple to the body 118 of the locking cable 107. The lock casing 204 can be at a fixed position along the body 118 of the locking cable 107 or the lock casing 204 can be movable along the body 118 of the locking cable 107.

As shown in FIG. 4, the lock casing 204 can include a first portion 206 and a second portion 208. The lock casing 204 can include a channel 210 to receive the body 118 of the locking cable 107. The channel 210 can be bounded at least in part by the first portion 206 and the second portion 208. The lock casing 204 can include a first opening 211 and a second opening 212. The openings 211, 212 can be in the same wall or different walls of the lock casing 204.

The securement 200 can include a reel 214, such as a spring-biased spool, and a retractable cord 216, such as a metal wire having a diameter of at least about 1 mm. The reel 214 can be positioned within the lock casing 204. The reel 214 can be coupled to an inner wall of the lock casing 204. The retractable cord 216 can have a first end and a second end 217. The first end of the retractable cord 216 can be coupled to the reel 214. The second end 217 of the retractable cord 216 can extend out of the lock casing 204 through the first opening 211. In an unlocked configuration, a length of the retractable cord 216 can be wound about the reel 214. In the locked configuration, at least a portion of the retractable cord 216 can be unwound from around the reel 214. The second end 217 of the retractable cord 216 can be pulled by a user to unwind the retractable cord 216 from around the reel 214 to an extended length that allows the user to wrap the retractable cord 216 around the stationary object, for example a chair or table leg, and then returned into the opening 212 for locking, as discussed below.

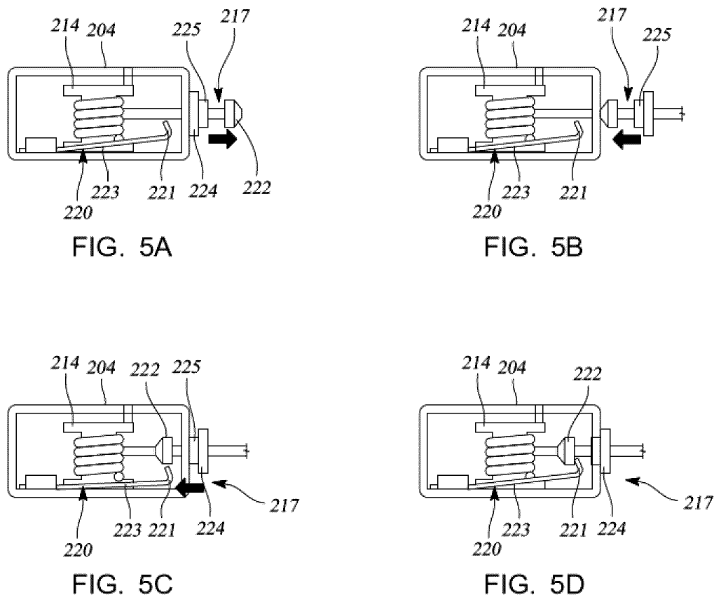

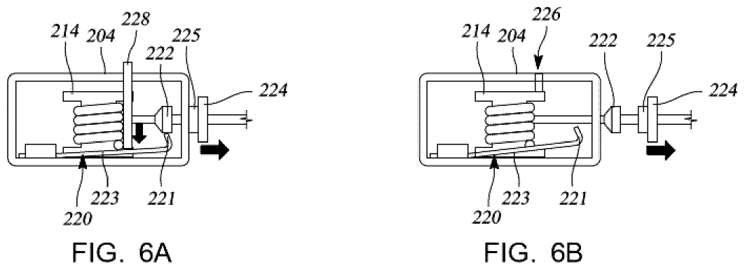

The securement 200 can include a releasable capture mechanism 220 as shown in FIGS. 5A-6B. The releasable capture mechanism 220 can be coupled to an inner surface of the lock casing 204. The releasable capture mechanism 220 can secure the second end 217 of the retractable cord 216 to the lock casing 204 when in the locked configuration. At least a portion of the second end 217 of the retractable cord 216 can be disposed within the lock casing 204 when in the locked configuration. The releasable capture mechanism 220 can be movable from a first position to a second position. FIGS. 5A, 5B, 5D, and 6B illustrate the releasable capture mechanism 220 in the first position. FIGS. 5C and 6A illustrate the releasable capture mechanism 220 in the second position. The transition of the releasable capture mechanism 220 from the first position to the second position can allow the second end 217 of the retractable cord 216 to be inserted and secured within the lock casing 204. A first end of the releasable capture mechanism 220 can be coupled to an inner surface of the lock casing 204. The releasable capture mechanism 220 can include a grasp end 221. The grasp end 221 can be a hooked end. The grasp end 221 can be a free end. A body 223 of the releasable capture mechanism 220 can extend from the first end to the grasp end 221. The releasable capture mechanism 220 can be spring biased. The grasp end 221 can secure the second end 217 of the retractable cord 216 to the lock casing 204.

The second end 217 of the retractable cord 216 can include a tapered portion 222 (e.g., a wedge) and a stopper 224. The tapered portion 222 can be spaced a distance from the stopper 224 by a gap. The tapered portion 222 can be inserted through the opening 212 in the lock casing 204 to secure the securement 200 in the locked configuration. The stopper 224 can remain outside the lock casing 204 both in the locked configuration and unlocked configuration. The stopper 224 can be sized such that the stopper 224 does not fit through either of the openings 211, 212. The stopper 224 can maintain a portion of the second end 217 of the retractable cord 216 outside the lock casing 204, and thus accessible for gripping by a user. When in the locked configuration, the gap between the stopper 224 and the tapered portion 222 can be within the lock casing 204.

The second end 217 of the retractable cord 216 can include an alignment element 225, such as a ring. The alignment element 225 can extend from a surface of the stopper 224. The alignment element 225 can rest within the opening 212 when the securement 200 is in the locked configuration. The alignment element 225 can be sized to approximately correspond to the size of the opening 212. The alignment element 225 can align the second end 217 relative to the lock casing 204 to facilitate engagement of the second end 217 with the releasable capture mechanism 220 and/or can inhibit or prevent the securement 200 from unintentionally unlocking by maintaining the second end 217 of the retractable cord 216 in the intended position.

To activate the securement 200 (for example after the user has wrapped the retractable cord 216 around a stationary object), the second end 217 of the retractable cord 216 can be inserted into the opening 212. The tapered portion 222 can deflect the grasp end 221 of the releasable capture mechanism 220 when the tapered portion 222 is inserted into the lock casing 204. The grasp end 221 can be angled such that it corresponds to the taper of the tapered portion 222. The corresponding angle and/or taper can allow the tapered portion 222 to easily the deflect the grasp end 221. The grasp end 221 can deflect away from a longitudinal axis of the lock casing 204. As the second end 217 is inserted further into the lock casing 204, the grasp end 221 reaches and end of the taper and falls into the gap. For example, once inserted such that a surface of the stopper 224 rests against an outer surface of the lock casing 204, the grasp end 221 can return to the first position and rest within the gap between the tapered portion 222 and the stopper 224 of the second end of the retractable cord 216. The grasp end 221 can inhibit or prevent the second end of the retractable cord 216 from easily being removed from the lock casing 204.

FIGS. 6A and 6B illustrate a method of unlocking the securement 200. The lock casing 204 can include an aperture 226. The aperture 226 can be positioned such that the aperture 226 aligns with a portion of the releasable capture mechanism 220. The aperture 226 can receive a pin 228 or other elongate element to disengage the releasable capture mechanism 220 and allow the second end 217 of the retractable cord 216 to be removed from within the lock casing 204. The pin 228 can apply a force to disengage the releasable capture mechanism 220. The applied force can move the releasable capture mechanism 220 to the second position which can remove the grasp end 221 from the gap between the stopper 224 and the tapered portion 222. The second end 217 can then be removed from within the lock casing 204. The releasable capture mechanism 220 can return to the first position when the pin 228 is removed from the lock casing 204 and the aperture 226. The retractable cord 216 can then retract back to a positioned wound about the reel 214 within the lock casing 204. The reel 214 can be spring biased to auto-retract the retractable cord 216 back into the lock casing 204.

As will be appreciated from the discussion above, in some implementations, the portion of the second end 217 of the retractable cord 216 that engages with the lock casing 204 is reversible. For example, as shown in FIG. 5A, when the retractable cord 216 is in an unlocked and retracted state, the stopper 224 engages adjacent the opening 211 and the tapered portion 222 is spaced apart from the lock casing 204. This enables the tapered portion 222 to act as a grip or handhold for the user for the retractable cord 216. As shown in FIG. 5D, when the retractable cord 216 is in a locked and unretracted (e.g., deployed) state, an opposite side of the stopper 224 engages adjacent the opening 212 and the tapered portion 222 is inside the lock casing 204. Thus, the position of the second end 217 of the retractable cord 216 relative to the lock casing 204 is reversed based on whether the retractable cord 216 is in the locked or unlocked state.

While the above detailed description has shown, described, and pointed out novel features of the present disclosure as applied to various examples, it will be understood that various omissions, substitutions, and changes in the form and details of the device or process illustrated may be made by those skilled in the art without departing from the spirit of the present disclosure. As will be recognized, the present disclosure may be embodied within a form that does not provide all of the features and benefits set forth herein, as some features may be used or practiced separately from others. All changes which come within the meaning and range of equivalency of the claims are to be embraced within their scope.

The term “comprising” as used herein is synonymous with “including,” “containing,” or “characterized by,” and is inclusive or open-ended and does not exclude additional, unrecited elements or method steps. With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

Unless otherwise explicitly stated, articles such as “a” or “an” should generally be interpreted to include one or more described items. Accordingly, phrases such as “a device to” are intended to include one or more recited devices. Such one or more recited devices can also be collectively configured to carry out the stated recitations. For example, “a processor to carry out recitations A, B and C” can include a first processor to carry out recitation A working in conjunction with a second processor to carry out recitations B and C. Unless otherwise explicitly stated, the terms “set” and “collection” should generally be interpreted to include one or more described items throughout this application. Accordingly, phrases such as “a set of devices to” or “a collection of devices to” are intended to include one or more recited devices. Such one or more recited devices can also collectively carry out the stated recitations. For example, “a set of servers to carry out recitations A, B and C” can include a first server to carry out recitation A working in conjunction with a second server to carry out recitations B and C.

All numbers expressing quantities, dimensions, and so forth used in the specification and claims are to be understood as being modified in all instances by the term “about.” Accordingly, unless indicated to the contrary, the numerical parameters set forth in the specification are approximations that may vary depending upon the desired properties sought to be obtained by examples of the present disclosure. At the very least, and not as an attempt to limit the application of the doctrine of equivalents to the scope of the claims, each numerical parameter should be construed in light of the number of significant digits and ordinary rounding approaches. For example, terms such as about, approximately, substantially, and the like may represent a percentage relative deviation, in various examples, of ±1%, ±5%, ±10%, or ±20%. The term “generally” as used herein represents a value, amount, or characteristic that predominantly includes or tends toward a particular value, amount, or characteristic. As an example, in certain embodiments, as the context may permit, the term “generally parallel” can refer to something that departs from exactly parallel by less than or equal to 20 degrees and the term “generally perpendicular” can refer to something that departs from exactly perpendicular by less than or equal to 20 degrees.

The above description discloses several devices, methods, and materials of the present disclosure. The present disclosure is susceptible to modifications in the devices, methods, and materials, as well as alterations in the fabrication methods and equipment. Such modifications will become apparent to those skilled in the art from a consideration of this disclosure. Consequently, it is not intended that the present disclosure be limited to the specific examples disclosed herein, but that it covers all modifications and alternatives coming within the true scope and spirit of the present disclosure.

What is claimed is:

1. A computing device comprising:
a casing defining an aperture;
a motherboard affixed to the casing, the motherboard including an input/output (I/O) port; and
a locking cable including:
a first end to connect to the I/O port, wherein the first end is to be disposed in the casing;
a body connected to the first end, wherein the body is to extend from inside the casing to outside the casing through the aperture; and
a second end connected to the body, the second end includes an I/O connector to interface with an electronic device.

2. The computing device of claim 1, wherein the first end of the locking cable includes a plug oriented generally perpendicular to a longitudinal axis of the body of the locking cable, the plug to couple with the I/O port.

3. The computing device of claim 1, wherein the first end of the locking cable includes a width that exceeds a width of the aperture.

4. The computing device of claim 1, wherein a first portion of the body of the locking cable is angled relative to a second portion of the body of the locking cable, the first portion inside the casing and the second portion outside the casing.

5. The computing device of claim 1, wherein the first end of the locking cable includes a recess and an inner surface of the casing includes a protrusion to be received within the recess.

6. The computing device of claim 1, wherein the first end of the locking cable is secured to the casing with a screw.

7. A computing device comprising:
a casing defining an aperture;
a motherboard affixed to the casing, the motherboard including an input/output (I/O) port;
a locking cable to couple with the I/O port; and
a securement to secure the locking cable to a stationary object, the securement including:
a lock casing coupled to the locking cable, the lock casing comprising an opening;
a reel in the lock casing;
a retractable cord comprising a first end and a second end, the first end coupled to the reel in the lock casing, the second end extendable out of the lock casing to wrap around the stationary object; and
a releasable capture mechanism to secure the second end of the retractable cord within the lock casing when the second end of the retractable cord is inserted through the opening in the lock casing.

8. The computing device of claim 7, wherein, during insertion of the second end of the retractable cord through the opening in the lock casing, the releasable capture mechanism transitions from a first position to a second position to allow the second end of the retractable cord to be inserted into the lock casing.

9. The computing device of claim 8, wherein the releasable capture mechanism is biased by a spring to the first position.

10. The computing device of claim 7, wherein the lock casing further comprises an aperture to receive a pin to disengage the releasable capture mechanism to allow the second end of the retractable cord to be removed from within the lock casing.

11. The computing device of claim 7, wherein the second end of the retractable cord comprises a tapered portion spaced a distance by a gap from a stopper, the tapered portion and gap receivable within the lock casing.

12. The computing device of claim 11, wherein the securement comprises a hooked end to be deflected by the tapered portion and received within the gap.

13. The computing device of claim 11, wherein the stopper is to remain outside the lock casing when the second end of the retractable cord is inserted into the lock casing.

14. The computing device of claim 7, wherein the reel is spring biased to auto-retract the retractable cord.

15. A computing device comprising:
a casing defining an aperture;
a motherboard affixed to the casing, the motherboard including an input/output (I/O) port;
a locking cable including:
a first end to connect the I/O port, wherein the first end is to be disposed in the casing; and
a second end including an I/O connector to interface with an electronic device; and
a securement coupled to the locking cable, the securement to secure the locking cable to a stationary object.

16. The computing device of claim 15, wherein the securement comprises a retractable cord to be coupled with a reel within a lock casing of the securement.

17. The computing device of claim 16, wherein the reel is spring biased to auto-retract the retractable cord.

18. The computing device of claim 15, wherein the first end of the locking cable comprises a plug oriented generally perpendicular to a longitudinal axis of a length of the locking cable, the plug to couple with the I/O port.

19. The computing device of claim 15, wherein a first portion of a body of the locking cable is angled relative to a second portion of the body of the locking cable, the first portion inside the casing and the second portion outside the casing.

20. The computing device of claim 15, wherein the securement comprises a spring biased lock.
